(19) United States
(12) Patent Application Publication
(10) Pub. No.: US 2004/0007244 A1
(43) Pub. Date: Jan. 15, 2004

(54) Personal care appliance housing

(76) Inventor: Michael Harms, Oberursel (DE)

Correspondence Address: FISH & RICHARDSON PC, 225 FRANKLIN ST, BOSTON, MA, 02110, US

(21) Appl. No.: 10/457,291

(22) Filed: Jun. 9, 2003

Related U.S. Application Data
(63) Continuation of application No. PCT/EP01/09156, filed on Aug. 8, 2001.

(30) Foreign Application Priority Data
Dec. 8, 2000 (DE) 100 61 327.6

(51) Int. Cl. A61C 15/00

(52) U.S. Cl. 132/322

(57) ABSTRACT

An electric toothbrush handle is disclosed that includes a housing with a first part and a second part, and an electric motor contained within the housing and operably connected to a shaft extending from the housing for driving a brush. The second housing part is removably connectable to the first housing part by a manually releasable latch that opens to disconnect the second housing part from the first housing part in response to squeezing the first housing part adjacent the latch.

### CROSS REFERENCE TO RELATED APPLICATIONS

This application is a continuation, claiming priority under 35 U.S.C. §120, of PCT application PCT/EP01/09156, filed Aug. 8, 2001, the contents of which are incorporated herein by reference, and claims priority under 35 U.S.C. §119(a) from German Patent Application No. 100 61 327.6, filed Dec. 8, 2000.

### TECHNICAL FIELD

This invention relates to personal care appliance housings, and more particularly to electric toothbrush handles.

### BACKGROUND

Electrical appliances for personal needs, such as toothbrushes, shavers, small domestic appliances, diagnostic devices or the like, are also used in wet surroundings, such as for example over washbasins. They are generally or occasionally cleaned under running water, in order for example to rinse away remains of toothpaste or other residues. To protect the electrical components such as the drive motor and controller from moisture, the housing should be formed in a waterproof manner to the extent that no water can penetrate into the interior of the housing. Problems may arise here, however, whenever the housing has to be opened. This is necessary in particular in the case of appliances operated by battery or storage battery, in which the corresponding batteries or storage batteries should or have to be exchanged regularly. In the case of such electric toothbrushes or the like which can be operated independently of an electrical power supply system, a battery- or storage-battery-receiving compartment is provided inside the housing and is closed by a cover. In this case, the joint between the two housing parts is to be formed in such a way that the penetration of water is prevented. However, the previously proposed housings are in need of improvement in this respect.

### SUMMARY OF THE INVENTION

The present invention relates to a housing, in particular of an electric toothbrush or the like, with a housing body comprising two housing parts, and also releasable connecting means for releasably connecting the two housing parts. In one broad aspect an electric toothbrush handle is disclosed that includes a housing with a first part and a second part and an electric motor contained within the housing and operably connected to a shaft extending from the housing for driving a brush. The second housing part is removably connectable to the first housing part by a manually releasable latch that opens to disconnect the second housing part from the first housing part in response to squeezing the first housing part adjacent the latch. According to some embodiments, the handle includes a first elastically deformable finger extending from one side of the first housing part, and a second elastically deformable finger extending from an opposite side of the first housing part. Each of the fingers has a cam surface at a distal end. The second housing part defines opposing cavities arranged to receive the cam surfaces of the fingers as the first and second housing parts are connected to each other. Squeezing the first housing part adjacent the fingers moves the cam surfaces out of the cavities of the second housing part.

In some instances the distal ends of the fingers are positioned beneath actuating portions defined in the first housing part (3), such that pressing on the actuating portions displaces the fingers away from the second housing part. Certain embodiments include a spring positioned within the housing and arranged to bias the first part away from the second part. In some instances the spring is an electrical contact positioned to mate with a terminal of a battery positioned within the battery-receiving compartment.

Certain embodiments include a switch for positioned within the housing and externally operable through a deformable plastic portion of the housing. According to some arrangements, removing the first housing part from the second housing part exposes a battery compartment in the housing. According to some embodiments, an o-ring seal is between the first housing part and the second housing part. In some instances, the latch is part of an insert securely fastened to the first housing part, that includes a first elastically deformable finger extending from one side of the first housing part and a second elastically deformable finger extending from an opposite side of the housing. Each of the fingers has a cam surface at a distal end. The second housing part defines opposing cavities arranged to receive the cam surfaces of the fingers as the first and second housing parts are connected to each other. Squeezing the first housing part adjacent the fingers moves the cam surfaces out of the cavities of the second housing part. According to some embodiments, the first housing part is elongated, and the second housing part is a cap positionable over an open end of the first housing part. Some implementations include a shaft extending through the first housing part at a first end. In such instances, the second housing part is connectable at an opposite end of the first housing part.

According to a second broad aspect, a housing for a personal needs appliance is disclosed that includes a housing body with a first part and a second part (4), and a latching device positioned within the housing body and adapted to releasably connect the first part to the second part. The latching device can be disengaged by partially deforming the housing body. Certain embodiments include a prestressing device between the first part and the second part to press the first part and the second part away from each other when the latching device is disengaged. The prestressing device, in some implementations, includes a spring-loaded battery contact positioned within the housing body. In certain implementations the latching device includes a first latching hook firmly connected to the first housing part and an undercut, secured to the second housing part. The undercut complements the latching hook. In some embodiments, the undercut is positioned on an inner wall of the second part and the first latching hook is tongue-shaped. According to particular embodiments, the latching device also includes a second latching hook positioned within the housing, diametrically opposed to the first latching hook. Respective free ends of the first and second latching hooks form free legs of a substantially U-shaped latching clip.

According to some implementations, the housing includes a clip spring for prestressing the latching device into its engaged position. Certain embodiments include a housing body having a substantially elliptical cross section with a substantially flattened portion. The latching device is positioned beneath the substantially flattened portion. The housing body comprises a first, easily deformable material and a second material. The first, easily deformable material defines an actuating portion near the latching device and a functional portion near a switch that is positioned within the housing. The first, easily deformable material is a soft plastic; and the second material is a hard plastic. The housing is formed by a two-step injection-molding process. In some embodiments, the latching hook is part of an insert piece positioned within the first housing part. According to certain embodiments, the housing includes a battery-receiving compartment and a drive motor receiving compartment and the latching hook is integrally formed with the battery-receiving compartment and the drive-motor-receiving compartment. In some instances, the first housing part and the second housing part each have a substantially annular cross section. The first housing part is positionable relative to the second housing part in such a way that an annular portion of the first housing part overlaps an annular portion of the second housing part.

In some instances, the first housing part is adapted to accommodate an electrical motor, a drive train and an energy source and the second housing part forms a cover for closing the first housing part. In some embodiments, the first and second housing parts are connected to each other in a waterproof manner. Certain embodiments include a seal arranged between the first and second housing parts to prevent water ingress into the interior of the housing body. In certain circumstances, the seal is positioned to be movable along an axis defined by the direction in which the second housing part is pressable onto the first housing part. In certain embodiments, the seal is movable over a distance, which is at least as great as a distance necessary for the first housing part to engage the second housing part. According to some implementations, the seal is positioned radially between the first and second housing parts. Certain embodiments include the seal having an o-ring seated on the first housing part and rollable along an axis defined by the direction in which the first housing part is pressable onto the second housing part. In some instances the seal is accommodated in an annular recess on the outer circumference of the first housing part having a width along an axis defined by the direction in which the first housing part is pressable onto the second housing part. The width is a multiple of the thickness of the O-ring. In certain embodiments the first and second housing parts each have respective cylindrical sealing surfaces, which are positionable one over the other to form a sealing press fit therebetween. In some embodiments the cylindrical sealing surface of the second housing part has a conical run-out toward its edge.

According to certain embodiments, the personal care/needs appliance is an electric toothbrush. In other embodiments, the appliance is a shaver. In still other embodiments, it is an electrical diagnostic device.

The connecting means between the two housing parts are formed as a latching device, which is arranged inside the housing body and can be unlocked by the housing body being at least partially pressed together. To close the housing body, the two housing parts can be positively snap-fitted one onto the other. When the two housing parts are joined one onto the other, the latching device locks automatically.

A corresponding prestressing device between the two housing parts can achieve the effect that the two housing parts are automatically pressed apart after the latching device has been unlocked, so that the housing body opens of its own accord, as it were. In particular, the prestressing device may be formed by a battery contact-spring device inside the housing body. When the housing body is closed, for example after changing the batteries or a storage battery, the two housing parts are pressed together against the spring force of the battery contact-spring device, which then ensures after the unlocking of the latching device that the two housing parts are moved apart of their own accord.

The latching device for connecting the two housing parts may be formed in various ways. It preferably comprises a latching hook, in particular in the form of a tongue, which is firmly connected to the one housing part, and also an undercut on the inner wall of the other housing part, which complements the latching hook and into which the latching hook positively engages when the two housing parts are joined together. A projection over which the latching hook can be pushed and behind which the latching hook can engage may be formed integrally on the inner wall of said other housing part.

In a certain configuration, the latching device has a pair of diametrically opposite latching hooks, in order to achieve secure locking and simple operation of the housing. The latching device preferably comprises a U-shaped latching clip, the free legs of which form the latching hooks. This latching clip and the housing part in which it is fastened are preferably formed as separate components. As a result, the most favorable material can be used for both components. Moreover, the housing part may be simpler to produce if the latching clip is separately formed and subsequently fastened on the corresponding housing part.

The latching clip is expediently elastically formed, to allow the corresponding locking and unlocking movements to be performed. It may be formed as a spring clip made of metal. According to a certain configuration, it is injection-molded from plastic.

The latching hooks or the latching tongues may themselves be elastically resilient, so that they can press into the corresponding latching recesses of their own accord. According to a certain configuration, a separate or additional prestressing device, preferably a clip spring, which prestresses the latching device into its locking position, is provided. In particular, the latching hooks are pressed apart or away from each other by the separate spring, in order to assist the latching engagement.

The housing body is formed such that it is substantially round in cross section. The housing body preferably has an approximately oval or elliptical cross section. As a result, the housing is given an orientation, so that it lies ergonomically in the correct alignment in the hand of its own accord. The pressing together of the housing body is facilitated, to allow the latching device to be unlocked in this way. The latching hooks of the latching device are expediently arranged on opposite flat sides of the flattened cross section of the housing body. The housing body can be pressed together more easily on its flat sides.

The housing body may have portions made of different material. In particular, the housing body may have an unlocking portion made of easily deformable soft material in the region of the latching device, in order to facilitate the pressing of the housing body for unlocking the latching device. Further functional portions made of soft, easily deformable material may be provided, for example to actuate the drive of the electric toothbrush. Under the soft functional portions of the housing, corresponding switches or actuating elements may be arranged. In particular, the housing body may be injection-molded from hard plastic and soft plastic in a two-component process. The hard plastic portions give the housing the required strength and the soft housing portions allow the deformation of the housing at predetermined locations, in order to actuate functional elements lying under them. In addition, it is ensured by the two-component injection-molding process that the housing body can be formed altogether in a waterproof manner in spite of the formation of movable functional portions.

In a particular embodiment, the latching device or part of the same, in particular the at least one latching hook, is formed by an insert piece, which can be pushed with an exact fit into one of the two housing parts in the manner of an insert and, in its inserted position, can be latched with this housing part. This insert, which forms part of the latching device for connecting the housing parts, preferably realizes further functions. In particular, the insert piece may serve for securing the batteries or storage batteries to be arranged inside the housing and/or for securing a drive motor. In an advantageous way, the insert piece may form an end limitation, which subdivides the interior of the housing and separates a battery-receiving compartment and a drive-motor-receiving compartment from each other and respectively delimits them at the extreme ends. Electrical contacts for the batteries or the storage battery, against which the batteries or the storage battery are pressed, are attached to the insert piece.

In a certain embodiment, the two housing parts to be joined, which form the housing body, respectively have an annular, preferably round and in particular oval or elliptical, cross section and have cylindrical overlapping portions, with which they can be pushed one over the other with an exact fit. The separating plane between the two housing parts is consequently perpendicular to the longitudinal direction of the housing, which is formed in an elongate manner overall. The joining direction of the two housing parts corresponds to the longitudinal axis of the housing.

In some embodiments, the one housing part forms a main housing part, which is intended for receiving an electrical drive, mechanical drive train, the batteries or the storage battery etc., while the other housing part forms a cover, with which the main housing part can be closed. In particular, it is the cover of a battery-receiving compartment.

To be able to protect the electrical components inside the housing reliably from water, the housing body, in some instances, is expediently formed in a waterproof manner or the two housing parts are connected to each other in a waterproof manner. According to a further aspect, a seal against water ingress into the interior of the housing is arranged between the two housing parts and is mounted movably in the joining direction (i.e., the direction in which the two housing parts are moved when they are connected to each other) of the two housing parts. The seal between the two housing parts may assist sealing of the joint between the two separable housing parts. The movable way in which the seal is provided may achieve easy opening and closing of the housing in spite of the seal arranged in between.

In some instances, radial clamping of the seal between the two housing parts is provided. Clamping of the seal transversely in relation to its mobility may allow high sealing forces to be achieved when the housing body is opened and closed, in spite of low assembly forces. The corresponding surface pressure may be achieved by the size of the gap between the two housing parts being smaller than the thickness of the seal arranged in between, so that the latter is pressed against the corresponding sealing surfaces of the housing parts.

In a particular implementation, the seal includes an O-ring seated on a lateral surface of one of the two housing parts in such a way that it can roll back and forth in the joining direction. The seal is movable in the joining direction over a distance that is approximately equal to or else greater than a distance necessary for the latching engagement of the two housing parts. This may prevent the seal from blocking the closing movement of the two housing parts in relation to each other and the latter having to be pushed one onto the other by overcoming the o-ring which forms the seal is seated in an annular recess on the outer circumference of the one housing part and the width of which in the joining direction is dimensioned in such a way that there is adequate play for the rolling back and forth of the o-ring when the housing body is closed and opened.

In certain embodiments, one housing part has a sealing surface lying on its inner circumference, while the other housing part has a likewise cylindrical sealing surface on its outer circumferential surface. The two housing parts are pushed one over the other with their cylindrical sealing surfaces, so that the sealing surfaces together form a press fit for the seal. When the two housing parts are pushed one onto the other, the O-ring on the one sealing surface rolls in the joining direction, rolling into the press fit between the two sealing surfaces. The one sealing surface which is formed on the inner circumference of the one housing part preferably has a conical run-out toward the edge of the corresponding housing part. This can facilitate the pushing onto the O-ring that is seated on the sealing surface on the outer circumference of the other housing part.

Implementation of the techniques and apparatus described herein may provide one or more of the following advantages. The two housing parts may be unlocked with only one hand. The housing body may be formed such that it is at least partially elastic, so that it can for example be easily pressed together by the thumb and index finger of one hand. The latching device can be arranged inside the housing body to enable unlatching by the housing body being pressed together in a simple operation. The arrangement of the latching device within the housing body can provide an aesthetically pleasing and elegant look to the housing. In certain embodiments, automatic pressing or springing apart of the housing parts of the housing body may be provided as soon as the latching device is unlocked. This may simplify the handling of the housing and improve operational reliability of the housing. Appliances that are not properly closed might be detected immediately and simply, since the housing parts could be visibly pressed apart by a prestressing force. The spring loaded battery contact spring can, for example, provide a force for securing the batteries in place, an electrical connection for the batteries, and provide assistance in a one-handed operation of the housing, since the two housing parts can moved apart by it after the latching device has been unlocked.

The details of one or more embodiments are set forth in the accompanying drawings and the description below. Other features, objects, and advantages will be apparent from the description and drawings, and from the claims.

### BRIEF DESCRIPTION OF THE DRAWINGS

The invention is explained in more detail below on the basis of a preferred exemplary embodiment and associated drawings, in which:

FIG. 1 is a plan view of a narrow side of a housing of an electric toothbrush.

FIG. 2 is a plan view of the toothbrush from FIG. 1 turned through 90 degrees.

FIG. 3 is a longitudinal section through a toothbrush.

FIG. 4 is a longitudinal section through the toothbrush from FIG. 3, turned through 90 degrees.

FIG. 5 is a sectional view taken along the line indicated in FIG. 3.

Like reference symbols in the various drawings indicate like elements.

### DETAILED DESCRIPTION OF THE DRAWINGS

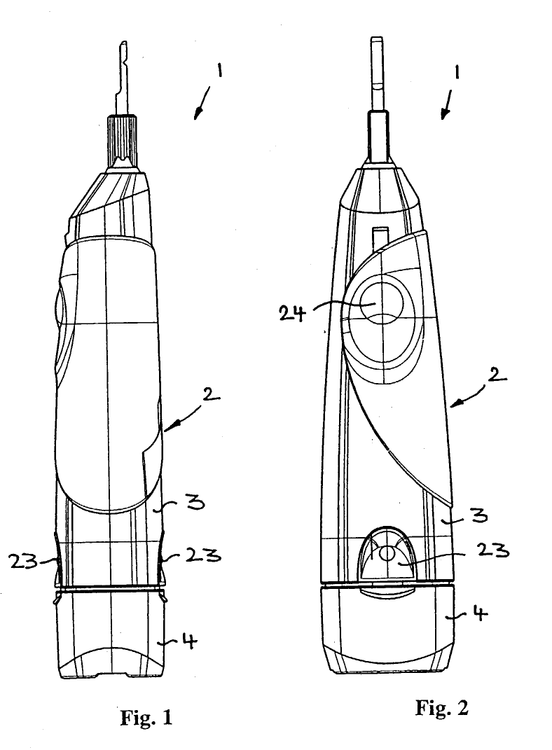

The electric toothbrush shown in the figures has a housing 1 (handle), which forms the hand-piece of the toothbrush and receives the electric drive for moving a brush mount (not represented). The housing 1 has an altogether elongate, tubular housing body 2 of a round or rounded cross section. As FIGS. 1 and 2 show, the housing body 2 is slightly flattened on opposite circumferential sides, so that an approximately oval or elliptical cross section is obtained overall.

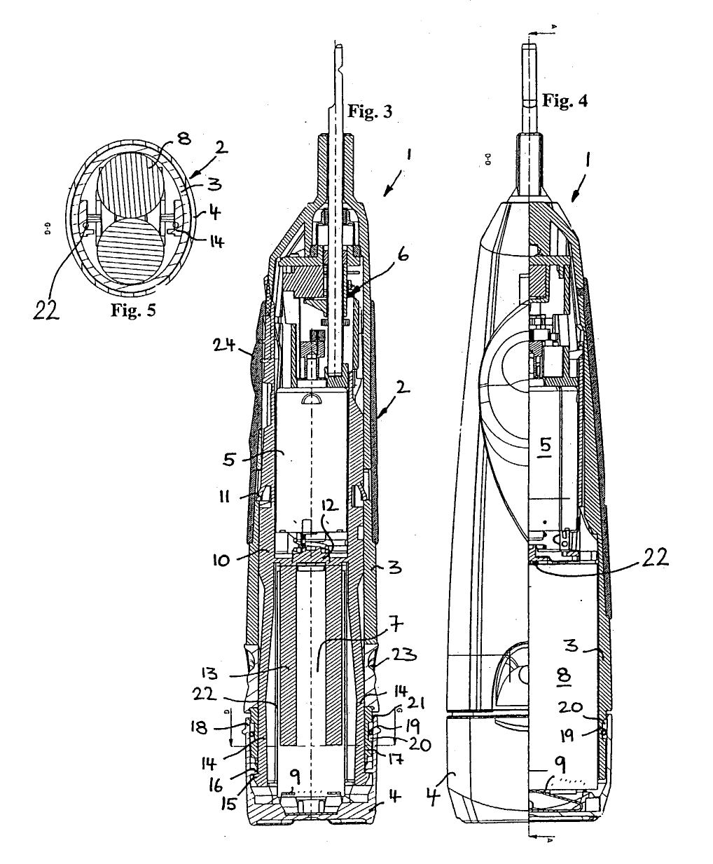

The housing body 2 comprises two housing parts 3 and 4, which can be joined together and separated from each other to open the housing 1 and allow access to the interior of the housing, as will be described in additional detail below. The first housing part 3 forms a main housing part, in which the electrical drive components and the drive mechanism for the brush mount (not represented) are accommodated. As FIG. 3 shows, an electric motor 5 and a drive train 6 driven by the electric motor are accommodated in the first housing part 3 and drive a brush head, which can be fitted onto the front end of the housing part 3, in a way known per se. A battery-receiving compartment 7 is located at the opposite end of the first housing part 3. Two batteries 8 can be arranged within the battery-receiving compartment 7 as an energy source for the electric motor 5 (FIG. 5).

The second housing part 4 forms a cup-shaped cover, with which the first housing part 3, in particular the battery-receiving compartment 7, can be closed. As FIG. 3 shows, the cup-shaped second housing part 4 itself forms part of the battery-receiving compartment 7. A contact-spring device 9, which presses the batteries 8 into the desired position and establishes the electrical connection, is arranged on the bottom of the cup-shaped second housing part 4.

As FIG. 3 shows, an insert piece 10, which is injection-molded from plastic, can be pushed into the interior of the first housing part 3 with an exact fit and can be latched there in a positionally fixed manner by means of latching hooks 11. The insert piece 10 forms a securing compartment for the electric motor 5 and separates the receiving compartment intended for the electric motor 5 from the battery-receiving compartment 7 by means of a transverse plate 12. Electrical contacts for the batteries 8 may be provided on the transverse plate 12 in order to connect the batteries to the drive. As FIG. 3 shows, formed onto the insert piece 10 are battery-securing struts 13, which protrude from the transverse plate 12 into the battery-receiving compartment 7 and subdivide the latter, so that the batteries 8 are held in their desired positions.

Also formed onto the insert piece 10 are tongue-shaped latching hooks 14, which extend on the inner circumference of the first housing part toward the second housing part 4. As FIG. 3 shows, the latching hooks 14 are formed such that they are relatively long. They extend from the base of the battery-receiving compartment 7, which is formed by the transverse plate 12 of the insert piece 10, almost over the entire length of the battery-receiving compartment, so that their free ends are elastically movable back and forth. As FIG. 5 shows in particular, two diametrically opposite latching hooks 14 are provided, which bear against the inner wall of the housing body 2 and can be moved in a radial direction with their free ends, onto which radially, outwardly directed latching projections 15 are formed.

The latching hooks 14 can serve to lock the second housing part 4 in its position closing the battery-receiving compartment 7. For this purpose, locking projections 16, behind which the latching projections 15 the latching hooks 14 can positively engage (cf. FIG. 3), are provided on the inner circumference of the second housing part 4.

To allow the housing body 2 to be closed in a precise manner, the two housing parts 3 and 4 each have annular overlapping portions 17 and 18, respectively. These overlapping portions 17 and 18 can be pushed one over the other with an exact or very tight fit. As FIG. 3 shows, the first housing part 3 can be pushed with its overlapping portion 17, formed at one end of the first housing part 3, into the second housing part 4, so that the overlapping portion 18 of the second housing part 4 lies radially over the overlapping portion 17 of the first housing part 3.

For the fluid-tight sealing of the housing body 2, a seal 19 is arranged between the two housing parts 3 and 4. The seal 19 closes the separating point between the two housing parts in a waterproof manner. The seal 19 is formed as an O-ring. It is seated on the outer circumference of the first housing part 3, to be more precise it is accommodated in a peripheral recess 20 on the outer circumference of the overlapping portion 17 of the first housing part 3. As FIG. 3 shows, the width of the recess 20 in the pushing-on direction of the second housing part 4 is several times greater than the thickness of the O-ring 19. As a result, the seal 19 in the form of the O-ring can roll back and forth in the longitudinal direction of the toothbrush, in order to facilitate the joining together and separating of the two housing parts 3 and 4. The size of the radial gap between the two housing parts 3 and 4 in the region of the seal 19 is expediently less than the thickness of the seal 19 in the form of an O-ring, so that the latter is pressed between the two housing parts 3 and 4 and seals the housing parts. The cylindrical bottom of the recess 20 and also the opposite, likewise cylindrical inner wall of the second housing part 4 in this case form the sealing surfaces against which the seal 19 bears. To facilitate the pushing-on of the second housing part 4, the inner wall of the second housing part 4 has at its edge a conical run-out 21 or a beveled edge, by which the O-ring is pressed under the second housing part 4 when it is pushed on.

The function and operating principle of the housing 1 when the battery-receiving compartment 7 is opened and closed is explained in more detail below.

To close the battery-receiving compartment, for example, after inserting new batteries, the second housing part 4 is pushed over the first housing part 3 in a longitudinal direction. In this case, the overlapping portion 18 of the second housing part 4 is pushed over the overlapping portion 17 of the first housing part 3. As soon as the second housing part 4 comes up against the seal 19 with its edge, facing the first housing part 3, the seal rolls along with the second housing part as it is pushed on, since the recess 20 is made wide enough for this. Although a high surface pressure is achieved on the seal 19 by corresponding choice of the size of gap, only low assembly forces need to be expended, since negligible static friction occurs. The friction consists mostly of only rolling friction between the housing parts 3 and 4 and the seal 19. Notably, sliding grease or other lubricant may not be required or even desirable near the seal 19. This may further facilitate and improve handling and assembly.

When the second housing part 4 is pushed on, it is automatically locked. The latching hooks 14 are pushed over the complementary locking projections 16. As the two housing parts are moved towards each other, the latching hooks 14 are pressed radially inward, i.e. toward one another. The latching hooks 14 are beveled in a wedge-shaped manner at the free ends on their radially outer side, so that when they slide over the locking projections 16 they are thereby pressed inward. As soon as the latching hooks 14 have been pushed far enough so their latching projections 15 are positioned over the locking projections 16, they spring radially outward, engage behind the locking projections 16 and lock the second housing part 4. To press the latching hooks 14 securely and reliably outward into their locking position, a separate prestressing device is provided in the form of a U-shaped clip spring 22, which bears against the radially inner side of the latching hooks 14 and presses them outward. The latching hooks 14 are themselves elastically formed. However, higher spring forces may be possible by using a separate clip spring 22.

When the second housing part 4 is pushed onto the first housing part 3, a prestressing of the contact-spring device 9 against the inserted batteries 8 takes place, i.e. the second housing part 4 is closed against the spring force of the contact-spring device 9, at least toward the end of the closing movement. As a result, the batteries 8 are pressed securely into their contact position. The contact-spring device 9 may perform further functions as well. For example, the contact spring device 9 may provide assurance that the second housing part 4 is pushed completely onto the first housing part 3. If the latching hooks 14 are not completely locked (engaged), the contact-spring device 9 presses the second housing part 4 down and possibly off of the first housing part 3. Also, the contact-spring device 9 may facilitate the automatic opening of the housing body 3 when the latching hooks 14 are unlocked. This may take place as follows. If the housing body 2 is pressed together in the region of the latching hooks 14, i.e. on its flat sides, for example by the thumb and index finger of one hand, this may unlatch the latching hooks 14 from the locking projections 16. When that occurs, the contact spring device 9 pushes the second housing part 4 away from the first housing part 3.

As FIG. 2 shows, the housing body 2 has special actuating portions 23, which are elastically deformable with low force, so that the housing can be easily pressed together on these portions. In particular, the first housing part 3 is injection-molded from different plastics. The base material of the first housing part 3 is preferably a hard plastic, for example PP, while functional portions such as the actuating portion 23 are injection-molded from easily deformable soft plastic, for example PP with a high plasticizer content. Apart from the actuating portion 23, a further functional portion 24 is provided in particular in the region of the housing 1 in which the thumb comes to lie during use of the toothbrush. A switch is positioned under this functional portion 24 for actuating the electric motor. A user could thereby actuate the electric motor by pressing the housing in this functional portion 24.

The actuating portion 23 of the first housing part 3 allows a user to manipulate the latching hooks 14 inside the housing to be pressed inwardly into an unlocked (i.e., disengaged) position. As FIG. 3 shows, the latching hooks 14 bear against the inner circumference of the actuating portions 23 of the first housing part 3 when they are in their locking position. To unlock the latching hooks 14, the first housing part 3 is pressed together on diametrically opposite actuating portions 23, arranged on flat sides of the housing. As a result, the latching hooks 14 are accordingly also pressed together, so that they disengage from the locking projections 16 on the inner circumference of the second housing part 4. As soon as the engagement is released, the second housing part 4 is pressed off of the first housing part 3 by the prestressing force of the contact-spring device 9. The seal 19 moves (i.e., rolls) as the two housing parts 3 and 4 are parted from each other, thereby allowing a relatively low force from the spring contact 9 to adequately separate the two housing parts 3 and 4 from each other.

The housing described, which preferably forms the housing of a toothbrush but may also be used in the case of other electrical appliances for personal needs, such as shavers, blood-pressure measuring devices, flashlights etc., considerably facilitates the handling when opening and re-closing the housing. At the same time, a waterproof encapsulation of the components arranged in the housing is achieved without great assembly forces being required. The arrangement of the connecting means of the two housing parts inside the housing allows an esthetic outer shape to be achieved. On the other hand, the arrangement of the inner latching hooks and of the seal in the form of an O-ring is distinguished by the only very small overall space requirement. Greater tolerances can be chosen without losing the sealing effect.

A number of embodiments of the invention have been described. Nevertheless, it will be understood that various modifications may be made without departing from the spirit and scope of the invention. For example, various materials may be used, the orientation of the actuating portions (23) may be varied, the relative size and arrangement of elements within the housing may vary, access to various functional elements may be provided in various ways, and sealing mechanisms other than an o-ring may be implemented. Accordingly, other embodiments are within the scope of the following claims.

What is claimed is:

1. An electric toothbrush handle comprising:
a housing comprising a first part and a second part; and
an electric motor contained within the housing and operably connected to a shaft extending from the housing for driving a brush;
wherein the second housing part is removably connectable to the first housing part by a manually releasable latch that opens to disconnect the second housing part from the first housing part in response to squeezing the first housing part adjacent the latch.

2. The electric toothbrush handle of claim 1 wherein the latch comprises:
a first elastically deformable finger extending from one side of the first housing part;
a second elastically deformable finger extending from an opposite side of the first housing part, each of the fingers having a cam surface at a distal end;
the second housing part defining opposing cavities arranged to receive the cam surfaces of the fingers as the first and second housing parts are connected to each other; and
wherein squeezing the first housing part adjacent the fingers moves the cam surfaces out of the cavities of the second housing part.

3. The electric toothbrush handle of claim 2 wherein the distal ends of the fingers are positioned beneath actuating portions defined in the first housing part, such that pressing on the actuating portions displaces the fingers away from the second housing part.

4. The electric toothbrush handle of claim 1 further comprising a spring positioned within the housing and arranged to bias the first part away from the second part.

5. The electric toothbrush handle of claim 4 further comprising a battery-receiving compartment wherein the spring comprises an electrical contact positioned to mate with a terminal of a battery positioned within the battery-receiving compartment.

6. The electric toothbrush handle of claim 1 further comprising a switch for actuating the electric motor; wherein the switch is positioned within the housing and is externally operable through a deformable plastic portion of the housing.

7. The electric toothbrush handle of claim 1 wherein the housing defines an internal battery compartment; wherein removing the first housing part from the second housing part exposes the battery compartment.

8. The electric toothbrush handle of claim 1 further comprising an o-ring seal between the first housing part and the second housing part.

9. The electric toothbrush handle of claim 1 wherein the latch comprises an insert securely fastened to the first housing part, the insert comprising:
a first elastically deformable finger extending from one side of the first housing part;
a second elastically deformable finger extending from an opposite side of the housing, each of the fingers having a cam surface at a distal end;
the second housing part defining opposing cavities arranged to receive the cam surfaces of the fingers as the first and second housing parts are connected to each other; and
wherein squeezing the first housing part adjacent the fingers moves the cam surfaces out of the cavities of the second housing part.

10. The electric toothbrush handle of claim 1 wherein the first housing part is elongated, and wherein the second housing part comprises a cap positionable over an open end of the first housing part.

11. A housing for a personal care appliance comprising:
a housing body comprising a first housing part and a second housing part; and
a latching device positioned within the housing body and adapted to releasably connect the first housing part to the second housing part, wherein the latching device is disengagable by partially deforming the housing body.

12. The housing of claim 11 further comprising a prestressing device arranged between the first housing part and the second housing part to press the first housing part and the second housing part apart when the latching device is disengaged.

13. The housing of claim 11 where the latching device comprises:
a first latching hook firmly connected to the first housing part; and
an undercut defined within the second housing part and arranged to receive the latching hook.

14. The housing of claim 13 wherein the latching device further comprises a second latching hook firmly connected to the first housing part and positioned opposite to the first latching hook.

15. The housing of claim 14 where the first latching hook and the second latching hook each have a respective free end and the respective free ends form free legs of a substantially U-shaped latching clip.

16. The housing of claim 13 wherein the latching hook is part of an insert piece (10) positioned within the first housing part (3).

17. The housing of claim 11 further comprising a clip spring for biasing the latching device into its engaged position.

18. The housing of claim 11 wherein the housing body comprises a first, compliant material and a second material.

19. The housing of claim 18 wherein the compliant material defines an actuating portion adjacent the latching device.

20. The housing of claim 18 wherein the compliant material defines a manipulable cover over a switch within the housing.

21. The housing of claim 18 wherein the compliant material is softer than, and molded in place over, the second material.

22. The housing of claim 11 wherein the first housing part defines both a battery-receiving compartment and a drive motor receiving compartment therein.

23. The housing of claim 11 wherein the first housing part is positionable relative to the second housing part in such a way that an annular portion of the first housing part overlaps an annular portion of the second housing part.

24. The housing of claim 11 wherein the first housing part is adapted to accommodate an electrical motor, a drive train and an energy source; and wherein the second housing part forms a cover for closing the first housing part.

25. The housing of claim 11 further comprising a seal arranged between the first housing part and the second housing part to prevent water ingress into the housing body.

26. The housing of claim 25 wherein the seal is movable over a distance at least as great as a distance necessary for the first housing part to engage the second housing part.

27. The housing of claim 25 wherein the seal is positioned radially between the first housing part and the second housing part.

28. The housing of claim 25 wherein the seal comprises an o-ring seated on the first housing part.

29. The housing of claim 28 wherein the o-ring is accommodated in an annular recess on an outer circumference of the first housing part, the recess having a width greater than a thickness of the o-ring.

30. The housing of claim 11 wherein the first housing part and the second housing part each comprise respective cylindrical sealing surfaces positionable one over the other to form a sealing press fit between the first housing part and the second housing part.

31. The housing of claim 30 wherein the cylindrical sealing surface of the second housing part has a conical run-out toward an edge of the second housing part.

32. The housing of claim 11 constructed as a housing for an electric toothbrush.

33. The housing of claim 11 constructed as a housing for a shaver.
